(19) United States
(12) Patent Application Publication
(10) Pub. No.: US 2023/0075746 A1
(43) Pub. Date: Mar. 9, 2023

(54) DUAL STRUCTURE HUMIDIFIER WITH NOISE REDUCTION FUNCTION

(71) Applicant: MIRO Co., Ltd., Incheon (KR)

(72) Inventors: Dong Jin SEO, Incheon (KR); Yong Ju OH, Incheon (KR); Min Seok KIM, Incheon (KR)

(21) Appl. No.: 17/704,388

(22) Filed: Mar. 25, 2022

(30) Foreign Application Priority Data
Sep. 2, 2021 (KR) 10-2021-0116884
Oct. 19, 2021 (KR) 10-2021-0139023

(51) Int. Cl. F24F 6/12; F24F 13/20; F24F 13/24

(52) U.S. Cl. CPC F24F 6/12; F24F 13/20; F24F 13/24; F24F 2006/008

(57) ABSTRACT

Provided is a dual structure humidifier, and more particularly, a dual structure floating-type humidifier with a noise reduction function. The dual structure humidifier includes a water tank in which a fluid is contained, a floating body which floats in the fluid in the water tank and performs a humidification operation using an ultrasonic module provided therein, a blowing fan which introduces external air into the water tank and the floating body or discharges the air in the floating body to the outside, and a water tank case which is provided to form a predetermined separation distance from the water tank and surround an outer circumference of the water tank and has air intake ports formed at one side to communicate with the blowing fan and reduce noise generated inside the water tank.

### CROSS-REFERENCE TO RELATED APPLICATIONS

This application claims the priority of Korean Patent Application No. 10-2021-0116884 filed on Sep. 2, 2021, and Korean Patent Application No. 10-2021-0139023 filed on Oct. 19, 2021, in the Korean Intellectual Property Office, the disclosures of which are incorporated herein by reference.

### BACKGROUND

### Field

The present disclosure relates to a dual structure humidifier, and more particularly, to a dual structure floating-type humidifier with a noise reduction function.

### Description of the Related Art

A humidifier is a typical seasonal home appliance mainly used in dry winter. However, recently, the humidifier has been used even in the spring and autumn when there is a lot of fine dust due to the influence of the atmospheric environment, and even in the summer when the air conditioner is used, the humidifier is used to prevent an indoor humidity from dropping excessively due to the cooling water of an air conditioner.

As such, the humidifier has become a representative home appliance used in all seasons. However, in the humidifier, various noises are generated inside the humidifier due to noise generated in a process of generating fine water droplets, noise generated by the rotation of a blowing fan, and noise generated by microvibrations.

In general, the humidifier is disposed and used not only in the living room, but also in the bedroom for comfortable sleep. Therefore, there is a need for a technology for reducing noise generated by the humidifier in order to prevent stressful insomnia and the like.

### SUMMARY

An object of the present disclosure is to provide a dual structure humidifier capable of reducing noise generated in a water tank through a dual structure of the water tank and a water tank case.

Another object of the present disclosure is to provide a dual structure humidifier capable of controlling a noise reduction degree through various types of air intake ports.

Another object of the present disclosure is to provide a dual structure humidifier capable of effectively reducing noise by a noise reduction member provided between a water tank and a water tank case.

The objects of the present disclosure are not limited to the above-mentioned objects, and other objects and advantages of the present disclosure, which are not mentioned, will be understood through the following description, and will become apparent from the exemplary embodiments of the present disclosure. In addition, it will be easily appreciated that the objects and advantages of the present disclosure will be realized by means illustrated in the appended claims and combinations thereof.

According to an aspect of the present disclosure, there is provided a dual structure humidifier including a water tank in which a fluid is contained, a floating body which floats in the fluid in the water tank and performs a humidification operation using an ultrasonic module provided therein, a blowing fan which introduces external air into the water tank and the floating body or discharges the air in the floating body to the outside, and a water tank case which is provided to form a predetermined separation distance from the water tank and surround an outer circumference of the water tank and has air intake ports formed at one side to communicate with the blowing fan and reduce noise generated inside the water tank.

In an exemplary embodiment of the present disclosure, the air intake port may be formed at a height lower than the top of the water tank with respect to the bottom surface of the water tank.

In an exemplary embodiment of the present disclosure, a plurality of air intake ports may be perforated and formed along the circumferential direction of the water tank case, and the water tank case may form a closed structure in which the lower portion is bent in a direction of the water tank to be connected to the lower portion of the water tank.

In an exemplary embodiment of the present disclosure, the air intake port may be provided in one shape of a plurality of perforated holes, and open surfaces and lines.

The dual structure humidifier according to an exemplary embodiment of the present disclosure may further include a noise reduction member in a space between the water tank case and the water tank to reduce the flow of the water tank case and prevent the water tank from colliding with the water tank case.

The dual structure humidifier according to an exemplary embodiment of the present disclosure may further include a fluid-particle discharge rod which is coupled to the upper portion of the floating body and guides the fluid particles generated by the humidification operation to be discharged upward to the outside.

The dual structure humidifier according to an exemplary embodiment of the present disclosure may further include a water tank cap which is coupled to the upper portion of the water tank and formed to correspond to the shape of the water tank case.

In an exemplary embodiment of the present disclosure, the fluid-particle discharge rod may be formed integrally with the water tank cap and the water tank case.

In an exemplary embodiment of the present disclosure, the water tank may be formed integrally with the water tank case.

The dual structure humidifier according to an exemplary embodiment of the present disclosure may further include a station which is in surface contact with the bottom surface of the water tank and is provided with a lighting device and a control unit for controlling the humidification operation.

According to the dual structure humidifier according to an exemplary embodiment of the present disclosure, it is possible to reduce noise generated in the water tank through the dual structure of the water tank and the water tank case.

In addition, according to the dual structure humidifier according to an exemplary embodiment of the present disclosure, it is possible to control the noise reduction degree through various types of air intake ports.

In addition, according to the dual structure humidifier according to an exemplary embodiment of the present disclosure, it is possible to effectively reduce noise by the noise reduction member provided between the water tank and the water tank case.

The effects of the present disclosure are not limited to the aforementioned effects, and various other effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view of a floating-type humidifier in the related art;

FIG. 2 is a lateral cross-sectional view of a dual structure humidifier according to an exemplary embodiment of the present disclosure;

FIG. 3 is an internal perspective view of a floating body according to an exemplary embodiment of the present disclosure;

FIG. 4 is an exploded view of a dual structure humidifier according to an exemplary embodiment of the present disclosure;

FIG. 5 is a perspective view of the dual structure humidifier according to an exemplary embodiment of the present disclosure from which a water tank case is removed;

FIG. 6 is a perspective view of a dual structure humidifier according to an exemplary embodiment of the present disclosure;

FIG. 7 is a lateral view of a dual structure humidifier according to an exemplary embodiment of the present disclosure;

FIG. 8 is a bottom perspective view of a dual structure humidifier according to an exemplary embodiment of the present disclosure; and

FIG. 9 is a perspective view of a dual structure humidifier according to another exemplary embodiment of the present disclosure.

### DETAILED DESCRIPTION OF THE PREFERRED EMBODIMENT

The present disclosure may have various modifications and various exemplary embodiments and specific exemplary embodiments will be illustrated in the drawings and described in detail in the detailed description. However, the present disclosure is not limited to specific exemplary embodiments, and it should be understood that the present disclosure covers all modifications, equivalents and replacements included within the idea and technical scope of the present disclosure. In describing each drawing, like reference numerals were used for like components.

Terms such as first, second, A, and B are used for describing various components, but the components are not limited by the terms. The terms are used only to discriminate one component from the other component. For example, without departing from the scope of the disclosure, a first component may be named as a second component, and similarly a second component may be named as a first component. A term ‘and/or’ includes a combination of a plurality of associated disclosed items or any item of the plurality of associated disclosed items.

It should be understood that, when it is described that a component is “coupled” or “connected” to the other component, the component may be directly coupled or connected to the other component, but there may be another component therebetween. In contrast, it should be understood that, when it is described that a component is “directly coupled to” or “directly connected to” the other component, it should be understood that there is no component therebetween.

Terms used in the present application are used only to describe specific exemplary embodiments, and are not intended to limit the present disclosure. Singular expressions used herein include plurals expressions unless they have definitely opposite meanings in the context. The terms “comprising” or “having” specify the presence of features, figures, steps, operations, components, parts, or combinations thereof disclosed in the present disclosure, but do not preclude the presence or addition of one or more other features, figures, steps, operations, components, parts, or combinations thereof.

Unless otherwise contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Hereinafter, preferred exemplary embodiments of the present disclosure will be described in detail with reference to the accompanying drawings.

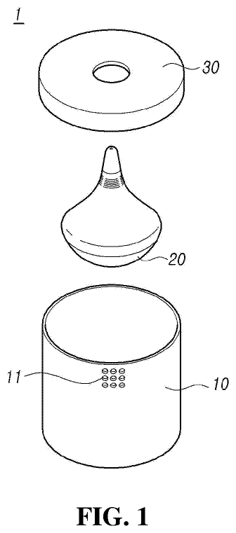

FIG. 1 is a perspective view of a floating-type humidifier in the related art.

Referring to FIG. 1, a floating-type humidifier 1 may include a tank 10, a floating body 20, and a water tank cap 30.

The water tank 10 contains a fluid therein, and the fluid may be, for example, water. Hereinafter, for convenience of description, it is assumed that the fluid is water.

The floating body 20 floats in the water tank 10 containing the fluid and performs a humidification operation. The bottom surface of the floating body 20 is inclined downward from the edge to the center, and a blowing fan (not illustrated) for introducing external air into the floating body 20 through rotational power may be provided.

The water tank cap 30 may be fitted to the upper portion of the water tank, and may have a hollow formed in the center so that the upper portion of the floating body 20 penetrates and is fixed. Accordingly, an upper portion of the floating body 20 protrudes to the outside through the hollow, discharges steam generated inside the floating body 20 to the outside, and performs a humidification operation.

On the other hand, a plurality of through holes 11 through which external air sucked through the blowing fan inside the floating body 20 penetrates may be provided at one upper side of the water tank 10. At this time, the noise generated inside the water tank 10 may be discharged in an opposite direction to the inflow direction of the external air through the plurality of through holes 11, but since the plurality of through holes 11 is positioned above the water tank 10, the generated noise is discharged to the outside without filtration. Accordingly, there is a problem in that large noise is generated during the operation of the humidifier.

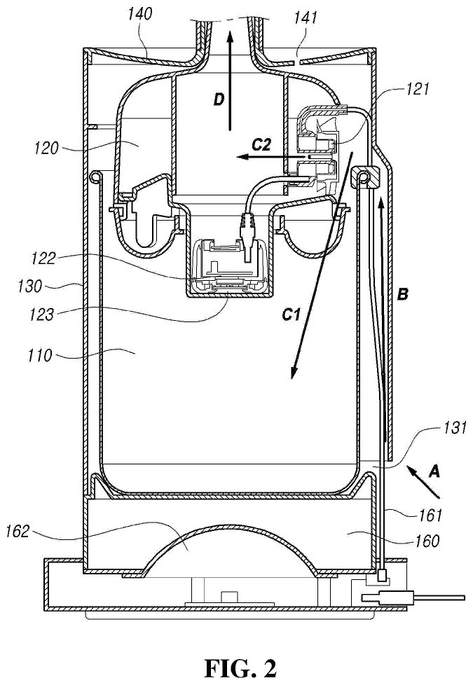

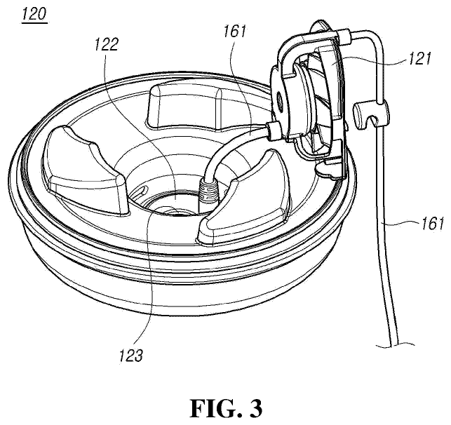

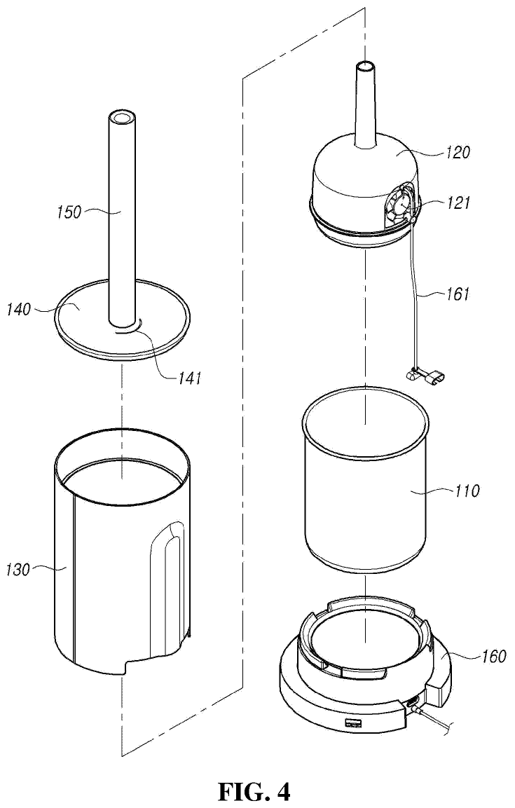

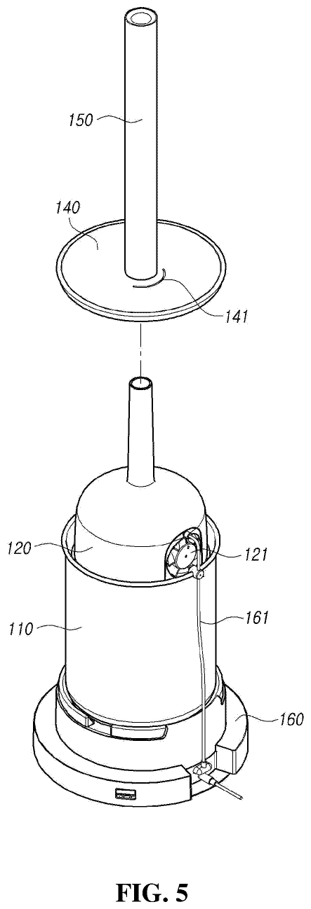

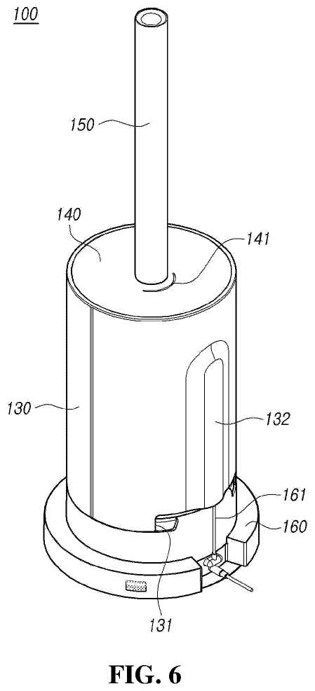

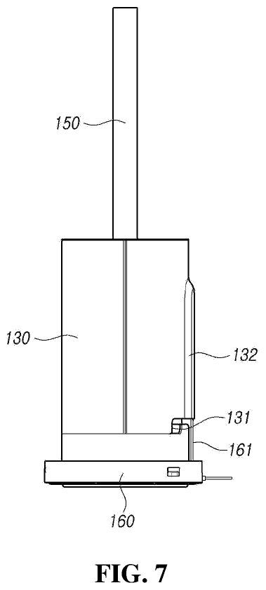

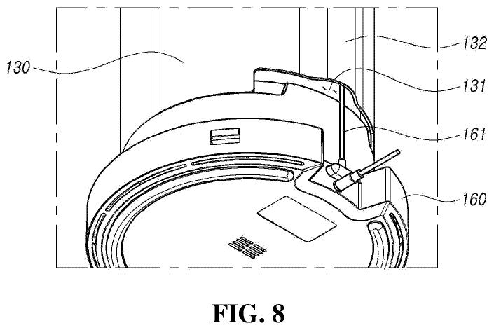

FIG. 2 is a lateral cross-sectional view of a dual structure humidifier according to an exemplary embodiment of the present disclosure, FIG. 3 is an internal perspective view of a floating body according to an exemplary embodiment of the present disclosure, FIG. 4 is an exploded view of a dual structure humidifier according to an exemplary embodiment of the present disclosure, FIG. 5 is a perspective view of the dual structure humidifier according to an exemplary embodiment of the present disclosure from which a water tank case is removed, FIG. 6 is a perspective view of a dual structure humidifier according to an exemplary embodiment of the present disclosure, FIG. 7 is a lateral view of a dual structure humidifier according to an exemplary embodiment of the present disclosure, and FIG. 8 is a bottom perspective view of a dual structure humidifier according to an exemplary embodiment of the present disclosure. Hereinafter, a dual structure humidifier will be described with reference to FIGS. 2 to 8.

Referring to FIGS. 2 to 8, a dual structure humidifier 100 may include a water tank 110, a floating body 120, a water tank case 130, a water tank cap 140, a fluid-particle discharge rod 150, and a station 160.

The water tank 110 is a space in which the fluid is contained, and the floating body 120 floats in the water tank 110 in which the fluid is contained.

A buoyancy space for generating buoyancy may be formed inside the floating body 120, and a fluid inlet hole 123 and an ultrasonic module 122 may be provided in a space protruding from the lower portion of the floating body 120 on the bottom surface of the floating body 120.

The fluid inlet hole 123 may be formed in a circular shape, and water may be introduced into the floating body 120 through the fluid inlet hole 123. The ultrasonic module 122 is inserted and installed into the floating body 120, and atomizes the water introduced into the lower portion of the floating body 120 through the fluid inlet hole 123 into water particles through ultrasonic vibration.

As illustrated in FIG. 3, a separate power supply cable 161 may be connected to the ultrasound module 122, and the power supply cable may extend to the outside through the floating body 120. The power supply cable 161 may supply power to the blowing fan 121 together with the ultrasonic module 122.

In an exemplary embodiment of the present disclosure, the floating body 120 may include the blowing fan 121. The blowing fan 121 introduces external air into the water tank 110 and the floating body 120, or discharges the air inside the floating body 120 to the outside.

Specifically, referring back to FIG. 2, the blowing fan 121 introduces the external air into the water tank 110 and the floating body 120 through the air intake port 131 of the water tank case 130 to be described below (A->B->C1 or A->B->C2), the introduced air passes through a hole formed in the upper portion of the floating body 120 together with the fluid particles (water particles) atomized by the ultrasonic module 122 to be discharged to the outside (D). The floating body 120 performs a humidification operation to supply moisture to a specific space through such an operation.

In the exemplary embodiment, it is expressed that the blowing fan 121 is included in the floating body 120 to be provided on the side of the floating body 120, but the position of the blowing fan 121 is not necessarily limited thereto, and may include all positions which may perform a function of introducing external air around the air intake port 131, above the water tank 110, on the inner circumferential surface of the water tank case 130, etc. into the water tank 110 and the floating body 120.

Referring to FIGS. 4 to 7, the water tank case 130 is provided to form a predetermined separation distance from the water tank and surround the outer circumference of the water tank 110. Accordingly, the diameter of the water tank case 130 is formed to be larger than the diameter of the water tank 110, and covers the outer circumferential surface of the water tank 110 to form a dual structure of the water tank 110 and the water tank case 130.

The air intake port 131 may be formed at one side of the water tank case 130 to communicate with a power supply cable guide portion 132, which protrudes to the outside so that the power supply cable 161 is accommodated in the inner circumferential surface, and the blowing fan 121. Accordingly, when the blowing fan 121 rotates, external air is introduced into the dual structure humidifier 100 through the air intake port 131.

On the other hand, in the dual structure humidifier 100, various noises may occur, such as noise caused by vibration of the ultrasonic module 122, noise caused by a rotational operation of the blowing fan 121, and noise caused by friction of water in the water tank 110.

In order to reduce these noises, the air intake port 131 may be formed at a height lower than the top of the water tank 110 with respect to the bottom surface of the water tank.

Since sound has straightness like light, the sound has an effect of reducing noise when passing through a curved section. Therefore, it is important to form a structure that prevents the generated noise from being directly discharged from the top of the water tank 110 to the outside.

Since the discharge path of the noise is opposite to the inflow direction of the external air illustrated in FIG. 2 through the air intake port 131 (C1->B->A or C2->B->A), when the air intake port 131 is formed at the height lower than the top of the water tank 110, the path through which the noise is discharged through the curved section is lengthened. Through such a path, the noise is reduced by friction with the outer circumferential surface of the water tank 110 and the inner circumferential surface of the water tank case 130.

In addition, as the height of the top of the water tank 110 is increased, the noise discharge path is increased to improve the noise reduction effect of the dual structure humidifier 100, so that the height from the bottom surface of the top of the water tank 110 may be formed to be sufficiently high.

In an exemplary embodiment, the air intake port 131 may have a planer shape in which the lower portion of the water tank case 130 is opened, as illustrated in FIG. 8, but the shape of the air intake port 131 is not necessarily limited thereto, and may have various shapes such as a plurality of perforated holes, and open surfaces and lines.

Meanwhile, in FIG. 8, as the height or size of the air intake port 131 is decreased, the noise reduction effect is improved. That is, when the height or size of the air intake port 131 is small, the introduced amount of external air is decreased, and thus, the size of noise to be generated is also decreased.

However, when the introduced amount of the external air decreases, the water particles to be discharged are also reduced, so that the humidification effect may be reduced. Accordingly, it is preferred that the size of the air intake port 131 is determined in the range of maintaining an appropriate humidification effect.

The water tank cap 140 is provided above the water tank case 130 and may be formed to correspond to the shape of the water tank case 130. The water tank cap 140 may be fitted with the upper portion of the water tank case 130, and may be mounted to be easily separated.

In addition, the water tank cap 140 is formed to correspond to the shape of the water tank case 130, thereby sealing the upper portion of the dual structure humidifier 130 together with the water tank case 130, preventing the fluid loss in the water tank 110, and reducing noise.

Referring back to FIG. 2, the water tank cap 140 may be provided with a drain hole part 141. The water tank cap 140 may be formed to be inclined downward in the center direction, and water generated from an outer surface of the water tank cap 140 due to a water droplet phenomenon is guided to the center of the water tank cap 140 along the inclination. Thereafter, the water accommodated in the center of the water tank cap 140 is introduced into the dual structure humidifier 100 along the drain hole part 141.

In the exemplary embodiment, the drain hole part 141 is expressed as a curved surface, but is not necessarily limited thereto, and may be formed in various shapes at various positions of the water tank cap 140.

The fluid-particle discharge rod 150 is coupled to the upper portion of the floating body 120, and guides the fluid particles generated by the humidification operation of the floating body 120 to be discharged upward to the outside. In an exemplary embodiment, the fluid-particle discharge rod 150 may be formed integrally with the water tank cap 140 and the water tank case 130, and when formed integrally, the sealing force is improved, so that the humidification force and the noise reduction effect may be improved.

In addition, in an exemplary embodiment, the water tank 110 may be formed integrally with the water tank case 130. In this case, there is an effect of reducing noise generated by friction with a space between the water tank 110 and the water tank case 130.

In addition, in another exemplary embodiment, the dual structure humidifier 100 may further include a noise reduction member (not illustrated) in the space between the water tank case 130 and the water tank 110. The noise reduction member may be made of a material capable of absorbing an impact, such as a sponge, and may reduce the flow of the water tank case 130 and prevent the water tank 110 from colliding with the water tank case 130. Therefore, when the noise reduction member is used, it is possible to prevent damage to the water tank case 130 due to the collision and reduce noise.

The station 160 is in surface contact with the bottom surface of the water tank 110, and may include a power supply unit (not illustrated), a control unit (not illustrated), and a lighting device 162 therein.

The power supply unit receives power from the outside to supply the power to the blowing fan 121 and the ultrasonic module 122 through the power supply cable 161, and the control unit controls the overall humidification operation of the dual structure humidifier.

The lighting device 162 may be, for example, a lighting using an LED, and may provide a visual effect to a user through various colors of light sources and luminance control.

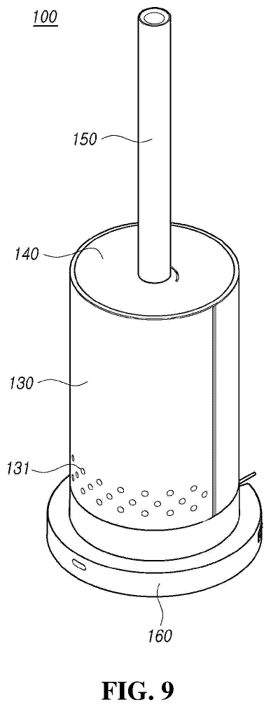

FIG. 9 is a perspective view of a dual structure humidifier according to another exemplary embodiment of the present disclosure.

Referring to FIG. 9, the water tank case 130 forms a closed structure in which the lower portion is bent in a direction of the water tank 110 to be connected to the lower portion of the water tank 110, and a plurality of air intake ports 131 may be perforated and formed along the circumferential direction of the water tank case 130.

The sizes of the air intake ports 131 may be different from each other, and as the sizes of the air intake ports 131 are decreased, noise is decreased, while since the amount of humidification decreases, the size of each air intake port 131 may be determined by considering the noise degree and the humidification amount.

As such, when the air intake ports 131 are formed of a plurality of perforated holes along the circumferential direction of the water tank case 130, the dual structure humidifier 100 may be disposed regardless of the direction of the air intake ports 131, so that convenience may be improved.

Table 1 illustrates a noise measurement result using a noise meter according to an exemplary embodiment of the present disclosure.

TABLE 1
Decibel difference between related art and present
disclosure using noise meter

| | Humidification | Humidification | Humidification |
|---|---|---|---|
| Classification | level 1 | level 2 | level 3 |
| Related art | 63.9 | 62.8 | 59.9 |
| Present disclosure | 36.2 | 38.5 | 42 |

Referring to Table 1, the humidifier has different noise levels according to a humidification amount. In the case of the related art illustrated in FIG. 1, the noise levels are 63.9 dB in a humidification level 1, 62.8 dB in a humidification level 2, and 59.9 dB in a humidification level 3, respectively. However, in the case of the present disclosure, the noise levels are 36.2 dB in a humidification level 1, 38.5 dB in a humidification level 2, and 42 dB in a humidification level 3, respectively, and as a result, it can be seen that the noise reduction effect is greatly improved in all stages as compared to the related art.

As described above, the dual structure humidifier according to an exemplary embodiment of the present disclosure may reduce noise generated inside the water tank through the dual structure of the water tank and the water tank case.

In addition, the dual structure humidifier according to an exemplary embodiment of the present disclosure may control the noise reduction degree through various types of air intake ports.

In addition, the dual structure humidifier according to an exemplary embodiment of the present disclosure may effectively reduce noise by the noise reduction member provided between the water tank and the water tank case.

As described above, the present disclosure has been described with reference to the illustrated drawings, but the present disclosure is not limited to the exemplary embodiments of the present disclosure and the drawings, and it will be apparent that various modifications can be made by those skilled in the art within the scope of the technical idea of the present disclosure. Further, it is natural that even though effects according to the configuration of the present disclosure are not explicitly described while describing the exemplary embodiments of the present disclosure above, expectable effects should be recognized by the configuration.

What is claimed is:

1. A dual structure humidifier comprising:
a water tank in which a fluid is contained;
a floating body which floats in the fluid in the water tank and performs a humidification operation using an ultrasonic module provided therein;
a blowing fan which introduces external air into the water tank and the floating body or discharges the air in the floating body to the outside; and
a water tank case which is provided to form a predetermined separation distance from the water tank and surround an outer circumference of the water tank and has air intake ports formed at one side to communicate with the blowing fan and reduce noise generated inside the water tank.

2. The dual structure humidifier of claim 1, wherein the air intake port is formed at a height lower than a top of the water tank with respect to a bottom surface of the water tank.

3. The dual structure humidifier of claim 2, wherein a plurality of air intake ports is perforated and formed along a circumferential direction of the water tank case, and
the water tank case forms a closed structure in which a lower portion is bent in a direction of the water tank to be connected to the lower portion of the water tank.

4. The dual structure humidifier of claim 2, wherein the air intake port is provided in one shape of a plurality of perforated holes, and open surfaces and lines.

5. The dual structure humidifier of claim 1, further comprising:
a noise reduction member in a space between the water tank case and the water tank to reduce a flow of the water tank case and prevent the water tank from colliding with the water tank case.

6. The dual structure humidifier of claim 1, further comprising:
a fluid-particle discharge rod which is coupled to an upper portion of the floating body and guides fluid particles generated by the humidification operation to be discharged upward to the outside.

7. The dual structure humidifier of claim 6, further comprising:
a water tank cap which is coupled to an upper portion of the water tank and formed to correspond to a shape of the water tank case.

8. The dual structure humidifier of claim 7, wherein the fluid-particle discharge rod is formed integrally with the water tank cap and the water tank case.

9. The dual structure humidifier of claim 7, wherein the water tank cap includes a drain hole part which guides water generated on an outer surface of the water tank cap to the inside of the water tank.

10. The dual structure humidifier of claim 1, wherein the water tank is formed integrally with the water tank case.

11. The dual structure humidifier of claim 1, further comprising:
a station which is in surface contact with a bottom surface of the water tank and is provided with a lighting device for providing lighting and a control unit for controlling the humidification operation.
